(19) United States
(12) Patent Application Publication
(10) Pub. No.: US 2009/0319897 A1
(43) Pub. Date: Dec. 24, 2009

(54) ENHANCED USER INTERFACE FOR EDITING IMAGES

(75) Inventors: Matthew J. Kotler, Sammamish, WA (US); L. Tucker Hatfield, Bothell, WA (US); Michael B. Fried, Woodinville, WA (US); Feng Zhu, Issaquah, WA (US); Heena Macwan, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/142,821

(22) Filed: Jun. 20, 2008

(51) Int. Cl. G06F 3/048

(52) U.S. Cl. 715/711; 715/838

(57) ABSTRACT

A digital image editing system and method are presented that allow a user to visualize a range of changes to an image. The system determines a range of parameter values for a parameter of a selected filter. Then, the system creates multiple thumbnails of the image where each thumbnail illustrates a representation of the image with a different parameter value within the range of parameter values of the filter applied to the image. The system displays the created thumbnails in a user interface from which a user can select a thumbnail to apply the parameter value represented by the selected thumbnail. Thus, the digital image editing system allows the user to visually select an appropriate parameter value among the values accepted by the filter.

### BACKGROUND

Image editing is the process of altering images, whether they be digital photographs, traditional analog photographs, or illustrations. Before digital scanners and cameras became common, traditional analog image editing was known as photo retouching and involved using tools such as an airbrush to modify photographs or editing illustrations with any traditional art medium. However, since the advent of digital images, analog image editing has become largely obsolete. Digital image editing software programs are the typical tools with which a user manipulates, enhances, and transforms digital images.

Digital images are often stored in a computer in the form of a grid of picture elements, or pixels. These pixels contain the image's color and brightness information at each location within the image. Image editing software can change the pixels, individually or as a group, to enhance the image in many ways. Due to the popularity of digital cameras, image editing software is readily available. Minimal programs that perform operations such as rotating and cropping images are often provided within the digital camera itself, while others are often standard features of personal computer operating systems. Programs that are more powerful contain functionality to perform a large variety of advanced image manipulations.

Images are often used in documents created by information workers that are not photographic experts. These users often need to edit an image to add more brightness, change the color saturation, apply a custom effect, and so forth. Applying filters or effects to images used in documents can be a frustrating experience for information workers due to the complexity of specialized editing tools, which often require intimate knowledge of how a filter works that is beyond the knowledge of the average information worker. Choices are often presented as simple icons, abstract numeric parameters, or labels such as “Brighter” or “Sharper” which convey only a general feeling for the effect the filter will have on the image. Even relatively simple tools provided within document-creation software can often prove difficult to use because they require some level of understanding of the underlying image manipulation in order to predict the outcome. While some editing software allows the user to see a preview of the changes in a window or allows the user to generate a set of potential choices, these still involve using unintuitive controls to define the parameters. For example, many applications present a visual slider where the user selects a low or high value in the range represented by the slider with no idea what effect each value will have.

On the other hand, image editing is a well-understood problem to advanced users, and advanced users often want fine-grained control over the image. It is often difficult to deliver an editing experience that provides novice users with the proper understanding of the effect of a filter and advanced users with the ability to fine tune effects to achieve a desired result.

### SUMMARY

A digital image editing system and method are presented that allow a user to visualize a range of changes to an image before applying one of them so that the user can choose an appropriate change. The digital image editing system receives a selection of a filter from a set of available filters. The system determines a range of parameter values for a parameter of the selected filter. The system creates multiple thumbnails of the image where each thumbnail illustrates a representation of the image with a different parameter value within the range of parameter values of the filter applied to the image. The system displays the created thumbnails in a user interface from which a user can select a thumbnail to apply the parameter value represented by the selected thumbnail. Thus, the digital image editing system allows the user to visually understand the changes that a particular filter will produce, and to select an appropriate parameter value among the values accepted by the filter.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a block diagram that illustrates the components of the digital image editing system, in one embodiment.

FIGS. 2, 3, and 4 are block diagrams that illustrate the parameter values underlying the thumbnail gallery for a particular filter or filters, in one embodiment.

FIG. 5 is a display diagram that illustrates a thumbnail gallery that the digital image editing system displays to the user, in one embodiment.

FIG. 6 is a display diagram that illustrates an advanced settings dialog box, in one embodiment.

FIG. 7 is a display diagram that illustrates the digital image editing system in the context of a document creation application, in one embodiment.

### DETAILED DESCRIPTION

A digital image editing system and method are presented that allow a user to visualize a range of changes to an image before applying one of them so that the user can choose an appropriate change. The digital image editing system allows the user to select a parameter value of a filter to apply to an image visually by displaying thumbnails that represent the effect on the image of various values of the parameter. The digital image editing system receives a selection of a filter from a set of available filters. For example, filters may be provided for adjusting the brightness, contrast, color saturation, and other attributes of an image. The system determines a range of parameter values for a parameter of the selected filter. For example, for a brightness filter the allowable parameter values may range from 0% to 100%, but the system may determine that the user will be most interested in a range from 20% to 40% as described further herein.

The system creates multiple thumbnails of the image where each thumbnail illustrates a representation of the image with a different parameter value within the range of parameter values of the filter applied to the image. For example, for the brightness filter the system may create a thumbnail for 20% brightness, another for 25% brightness, and so on in 5% increments up to 40% brightness. The system displays the created thumbnails in a user interface from which a user can select a thumbnail to apply the parameter value represented by the selected thumbnail. For example, the system may display the thumbnails in a strip from left to right, so that the user can select the one that makes the image appear how the user wants it to appear. If the user selects the thumbnail that represents 30% brightness, for example, then the system applies the brightness filter with a 30% parameter value to the image. Thus, the digital image editing system allows the user to visually understand the changes that a particular filter will produce, and to select an appropriate parameter value among the values accepted by the filter.

The digital image editing system makes previewing the effects of a filter on an image straightforward as well as making the process of changing or redoing the parameters of the filter simple enough to welcome experimentation even by novice (and often timid) users. The system also makes it easier to understand how different parameter values influence the image, which lowers the learning curve for those who wish to learn to make more detailed, manual settings. By integrating thumbnail-based galleries that allow users to visualize changes to an image with feedback that helps the user understand how the filter or effect works, the system helps users produce speedier, more accurate results with less fear and uncertainty.

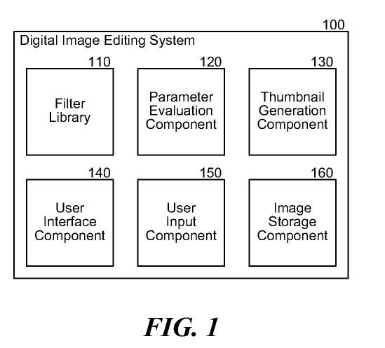

FIG. 1 is a block diagram that illustrates the components of the digital image editing system, in one embodiment. The digital image editing system 100 comprises a filter library 110, parameter evaluation component 120, thumbnail generation component 130, user interface component 140, user input component 150, and image storage component 160.

The filter library 110 contains one or more filters that the user can select to apply to an image. The digital image editing system 100 can create a thumbnail gallery for any filter or effect that changes the overall look of the image without changing the size, shape, or position of the image. Examples of such filters are brightness, contrast, sharpness, saturation, sepia toning, and so on. The system 100 may also allow the user to install new filters that integrate with the system to allow new effects to be applied to images. The filters in the filter library 110 receive a parameter or parameters that determine how the filter or effect will alter the image pixels to change the look of the image. For example, a brightness filter typically receives a percentage of brightness from zero to 100%. Applying the filter to the image with a higher percentage parameter value produces a brighter image.

The digital image editing system 100 displays a finite number of thumbnails and the parameter evaluation component 120 selects a finite set of parameter values for the thumbnails to represent. The parameter evaluation component 120 chooses the specific parameter values to lend a visual flow to the choices that emphasizes the function of the filter, thereby assisting the user in making a selection. Filters or effects with multiple parameters or more than one filter or effect can be combined, creating choices arranged in a fashion that illustrates a flow of artistic or creative choices. The user generally provides the image and the application will not have any previous knowledge of it. Thus, the application cannot be built to offer a predefined range of options for the image, so the parameter evaluation component 120 may determine the parameter values to illustrate dynamically. The parameter evaluation component 120 may use a variety of techniques to determine the range of parameter values to illustrate, from hard coding a range to heuristically determining the range based on attributes of the image itself. These techniques are described further below.

The thumbnail generation component 130 creates thumbnails based on the parameter values selected by the parameter evaluation component 120. The thumbnails are displayed in a gallery (e.g., a one or multi-dimensional matrix or other visual arrangement). The component 130 uses several factors to determine the size of the gallery to display. It is often desirable to be able to see the main image (or part of the main image) in a window behind the gallery, so the thumbnail generation component 130 may limit the number or size of thumbnails to allow the main image to be visible. It is also desirable to show a meaningful range of parameter values, so the component 130 may increase the number of thumbnails to offer the user more choices, particularly for filters with an effect that varies substantially throughout the parameter range.

The screen resolution of the computer on which the system 100 is used also influences the size of the thumbnail gallery, because the resolution determines the amount of available screen space. Using these factors, the thumbnail generation component 130 determines the size of the gallery. For example, the thumbnail generation component 130 may select a 5×5 grid that allows the system 100 to display five variations of two different settings and still show the main image in the background. After determining the size of the thumbnail gallery and the size of each thumbnail, the thumbnail generation component generates thumbnails of the main image by downsampling the main image and applying the filter or filters with the selected parameter values.

The user interface component 140 displays information to the user, including the main image and gallery of generated thumbnails described above. The user interface component 140 may also provide a detailed settings dialog for the user to select parameter values that lie between or beyond the preset values available in the thumbnail gallery. For example, if the thumbnail gallery displays thumbnails representing brightness parameter values from 20% to 60% in 10% increments, the user can use the detailed settings dialog to select values below 20%, above 60%, or at smaller than 10% increments between 20% and 60%. The detailed settings dialog allows advanced users to have more detailed control of the filter or effect.

The user input component 150 receives input from the user. The user may interact with the digital image editing system 100 through common methods of user input, such as a mouse, keyboard, stylus, and so on. The system 100 may display a cursor that the user can move to interact with different parts of the user interface. For example, as the user moves the cursor over a thumbnail in the thumbnail gallery, the user interface component 140 may change the main image to display a preview of the filter or effect using the parameter value represented by the thumbnail. The combination of a visually-oriented gallery and the live preview using the main image allows the user to quickly “home in” on a choice that fits the user's preferences. In some embodiments, if the cursor remains over the thumbnail for more than a certain period of time (e.g., one second), the user interface component 140 displays help text that reflects the parameter value associated with the thumbnail. For instance, the user interface component 140 may display “+20% brightness,” or “−20% saturation.” The help text allows the user to more clearly understand the parameters represented by the thumbnail, and to learn the correlation between the thumbnails and the visual change caused by the filter or effect.

The image storage component 160 manages the storage of images, such as between user editing sessions. In some embodiments, the images associated with the system 100 are embedded in a document. For example, word processing applications often allow users to insert images into documents, and the system 100 may be integrated with a word processing or other application to allow the user to edit images directly within the document. For example, the user may select an image and the word processing application may provide a toolbar for editing the image in the ways described further herein.

In some embodiments, the image store component 160 retains (or caches) an original version of the image and constructs the displayed image from the retained original version image using the filter or effect. In this way, the user can choose a different filter or effect or modify the parameters at any time within a session or in a different session. Since the original pixels are not changed this also eliminates the loss of quality that might occur from adding a filter or effect to an image that has previously been modified. As an example, a user might elect to sharpen an image by 10% in one session and decide in a later session that the sharpened image was too harsh and wish to decrease the sharpness. If the user were to do this by applying a second complementary operation, such as blur, the result would not be the same as having originally sharpened less. Since the original image is stored rather than adding a new operation to lower the sharpness of the previously sharpened image, the displayed image can be regenerated from the original using the new parameter.

In some embodiments, the image storage component 160 stores the original image and a list of filters and effects and their parameters that have been applied to the image as a filter chain or effect graph. The user interface uses the filter chain to render a displayable version of the image in the document at run time without changing the original image. This allows the user to add or remove filters and effects non-destructively. One advantage is that a document can be opened for subsequent edits and the filter chain can be changed or modified, allowing complete freedom to remove or alter filters added during earlier sessions. A second advantage is that repeated edits to the image do not cause degradation of the image.

The image storage component 160 may also store a flattened version of the image with all changes applied for compatibility with other applications. The flattened image may be stored in a common image format, such as GIF, JPEG, PNG, or BMP. Particularly with documents, it is common for many different applications to open and display a document of a particular format. For example, word processing documents created in one application (e.g., Microsoft Word) can often be opened by other applications (e.g., OpenOffice, WordPerfect). The other applications may not understand the original image plus filter chain stored by the image storage component 160 for use by the digital image editing system 100, but these applications may nevertheless be capable of displaying a flattened image with the changes the user has made. Thus, providing a flattened image provides a reasonable experience in other applications, even though the full editing capabilities of the digital image editing system 100 may only be available in the original application.

The computing device on which the system is implemented may include a central processing unit, memory, input devices (e.g., keyboard and pointing devices), output devices (e.g., display devices), and storage devices (e.g., disk drives). The memory and storage devices are computer-readable media that may be encoded with computer-executable instructions that implement the system, which means a computer-readable medium that contains the instructions. In addition, the data structures and message structures may be stored or transmitted via a data transmission medium, such as a signal on a communication link. Various communication links may be used, such as the Internet, a local area network, a wide area network, a point-to-point dial-up connection, a cell phone network, and so on.

Embodiments of the system may be implemented in various operating environments that include personal computers, server computers, handheld or laptop devices, multiprocessor systems, microprocessor-based systems, programmable consumer electronics, digital cameras, network PCs, minicomputers, mainframe computers, distributed computing environments that include any of the above systems or devices, and so on. The computer systems may be cell phones, personal digital assistants, smart phones, personal computers, programmable consumer electronics, digital cameras, and so on.

The system may be described in the general context of computer-executable instructions, such as program modules, executed by one or more computers or other devices. Generally, program modules include routines, programs, objects, components, data structures, and so on that perform particular tasks or implement particular abstract data types. Typically, the functionality of the program modules may be combined or distributed as desired in various embodiments.

As discussed above, the digital image editing system can use a variety of methods to select the parameter values that will be represented by the thumbnail gallery. According to one method, the digital image editing system selects parameter values within a predetermined common range of parameter values for a given filter of effect that are sufficiently pronounced to be noticeable. For example, through user testing or other methods, a brightness filter designer may determine that users cannot detect a change smaller than 5%, and that users rarely select greater than a 60% increase in brightness for an image. Using these values, the digital image editing system generates a gallery of thumbnails downsampled from the main image and applies the filter or effect to each thumbnail using parameter values within the determined range. In the present example, the system may create thumbnails in 5% increments from 40% to 60%.

In some embodiments, the digital image editing system chooses parameter values that are nonlinear. Parameter values can be linear (e.g., 10, 20, 30, 40) or nonlinear (e.g., 10, 25, 100, 200), in order to create the desired results in filters or effects. Depending on the filter selected, the system may choose a nonlinear set of parameter values if a linear set would not have a significant change between each thumbnail.

In some embodiments, the digital image editing system selects the parameter values heuristically. For example, the system may determine the parameter values based on past values selected by the user or by many users. The system may also examine attributes of the image itself to select the parameter values. For example, if the system determines that a picture is darker, then the system selects a greater brightness range.

In some embodiments, the digital image editing system determines an appropriate center point and selects parameter values around the center point. For example, many image editing programs have an auto adjust feature that attempts to select appropriate settings for the image. However, auto adjust often makes a poor choice of settings and many users have stopped using it. The digital image editing system can use the auto adjust settings as a center point for a range of adjustments to the image. Having multiple thumbnails to select from with varying parameter values makes it much more likely that one of the thumbnails in the gallery will be acceptable to the user.

In some embodiments, the system applies a reasonable approximation of the effect of a filter to the generated thumbnails. Some filters produce different results based on the resolution of the image to which they are applied. This can mean that applying such filters to thumbnails will have visibly different results than applying the filters to the main image. In such cases, the system may apply a substitute filter or substitute parameter value that achieves results that make the thumbnail more closely resemble what the main image would look like if the parameter values represented by the thumbnail were applied to the main image. Alternatively or additionally, the system may apply the filter to a copy of the main image and downsample the larger image to a thumbnail-sized image to more closely produce the desired effect.

The system may also exaggerate effects that appear subtle in the thumbnail but have a more noticeable effect when the image is larger. For example, if the effect overlays a hatch-mark pattern over the image having a size that is less visible in a thumbnail, the system may make the hatch mark pattern larger in the thumbnail to convey to the user the effect that the filter would have if applied to the main image. Another example is a filter that alters the image to resemble stained glass. The manner in which the image is broken into sections depends on both the parameter value selected and the resolution of the image. In these cases, the system selects the parameters for the thumbnail to reflect the appearance of the target image at normal resolutions. This allows the software designer to create galleries that clearly demonstrate the visual qualities the filter or effect produces as well as giving the user a clear understanding of the purpose of the filter or effect.

In some embodiments, the digital image editing system displays a multi-dimensional gallery of thumbnails. A two-dimensional gallery may represent a range of two different parameters of the same filter, where the x axis illustrates variations of the value of one parameter and the y axis illustrates variations of the value of another parameter. A two-dimensional gallery may also represent a range of parameters for two different filters. For example, brightness and contrast filters may be illustrated together in this way. The parameters may be associated with different filters or the multi-dimensional gallery may represent different parameters of a single filter or effect. For example, a stained glass filter may have a parameter that adjusts the size of the glass panes and another parameter that adjusts the transparency of the panes. Displaying a range of both parameters at the same time in a gallery allows the user to see the effect of the parameters not only individually but also in combination.

In some embodiments, after a user selects a thumbnail representing a particular parameter value from the thumbnail gallery for one filter, the digital image editing system displays the cumulative effect of the filter in the thumbnail gallery for subsequent filters. For example, after the user selects a thumbnail in a gallery illustrating brightness parameter values, the selected brightness shows up in the thumbnail gallery when the user later selects a color saturation filter. Thus, the user can visualize the cumulative effect of changing multiple filters by making particular changes to the parameters of each filter in succession.

The following figures illustrate some embodiments of the features of the digital image editing system described above.

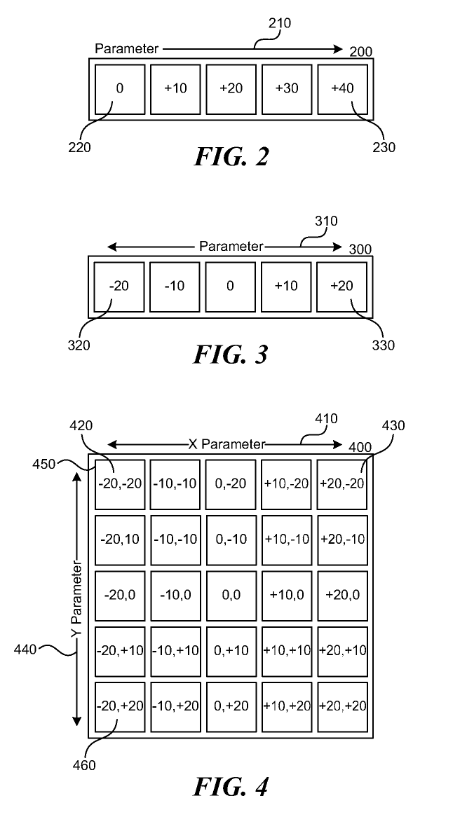

FIGS. 2, 3, and 4 are block diagrams that illustrate the parameter values underlying the thumbnail gallery for a particular filter or filters, in one embodiment. FIG. 2 contains a one-dimensional array 200 or strip of thumbnails. The array 200 displays several values of a filter parameter along an axis 210. The values range from zero at the first thumbnail position 220 to +40 at the last thumbnail position 230. For example, the system may present a filter such as brighten or sharpen in a manner that shows that the filter has a parameter value that can be increased in percentage increments. FIG. 3 also contains a one-dimensional array 300 with a single axis 310. However, the parameter values in FIG. 3 range from −20 in the first thumbnail position 320, to +20 in the last thumbnail position 340. For example, a filter such as color saturation can be presented in a manner that shows that it has a parameter that can be increased or decreased in percentage increments.

FIG. 4 illustrates a two-dimensional array 400 that contains an x-axis 410 and a y-axis 440. Along the x-axis 410, one parameter value ranges from −20 in the leftmost thumbnail position 420 to +20 in the rightmost thumbnail position 430. Along the y-axis 440, another parameter value also ranges from −20 in the topmost thumbnail position 450 to +20 in the bottommost thumbnail position 460. The two-dimensional array displays the effects of various combinations of the two parameter values. For example, the x-axis 410 may illustrate brightness and the y-axis 440 may illustrate contrast. Using the two-dimensional array 400 of thumbnails, the user can select a desired combination of these two parameters visually. The user does not actually see the values shown in FIGS. 2, 3, and 4, but rather sees a thumbnail at each position with a filter applied using parameter values like those shown. The digital image editing system may display the actual values to the user, for example, if the user hovers over a thumbnail the system may display the values shown to the user, or if the user opens an advanced settings dialog the system may show the parameter value or values applied to the currently selected thumbnail.

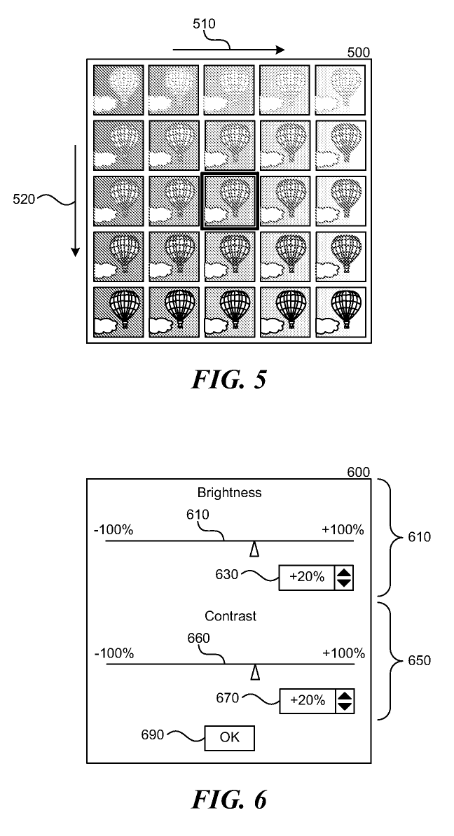

FIG. 5 is a display diagram that illustrates a thumbnail gallery that the digital image editing system displays to the user, in one embodiment. The display 500 contains a 5×5 gallery of thumbnails that illustrate a range of settings of both brightness and contrast. Along the x-axis 510, the brightness of the thumbnails increases from left to right. Along the y-axis 520, the contrast of the thumbnails increases from top to bottom. The center thumbnail is highlighted by a box drawn around it to indicate that the center thumbnail represents the currently selected parameter values. The display 500 illustrates the effect of 25 different combinations of the two parameters to the user, and is much more effective in conveying the effect to the user than if the user was setting an explicit value for each parameter one at a time.

FIG. 6 is a display diagram that illustrates an advanced settings dialog box, in one embodiment. The dialog 600 contains a brightness group 610 of advanced settings controls and a contrast group 650 of advanced settings controls. If changes have been made to an image using the gallery, the system displays the current values in the advanced controls. The brightness group 610 contains a slider control 620 and an edit/spin control 630. By dragging the slider control 620 from left to right, the user can select a brightness parameter value from −100% to +100%. Similarly, using the edit/spin control 630, the user can press the up or down arrows or enter an explicit value to set a parameter value for the brightness of the image. The contrast group 650 also contains a slider control 660 and an edit/spin control 670 similar to those described for brightness. Using the controls of the advanced settings dialog 600, the user can select parameter values in between or outside the range of those offered by the thumbnail gallery.

The thumbnail gallery may provide the user with an initial starting parameter value (or values) that is close to the desired result, and the user may fine tune the parameter value using the dialog 600. This allows the advanced user to make settings based on more detailed knowledge of photo editing as well as accommodating the editing of images that need correction beyond the norm. The advanced controls allow parameters not directly available in the gallery. If the user changes the settings manually to a parameter value not available in the gallery, the gallery will no longer display a highlight to indicate which thumbnail represents the current parameter value. However, the gallery will still display settings based on the original source image and the user may still use the gallery to choose a different set of parameters, if desired.

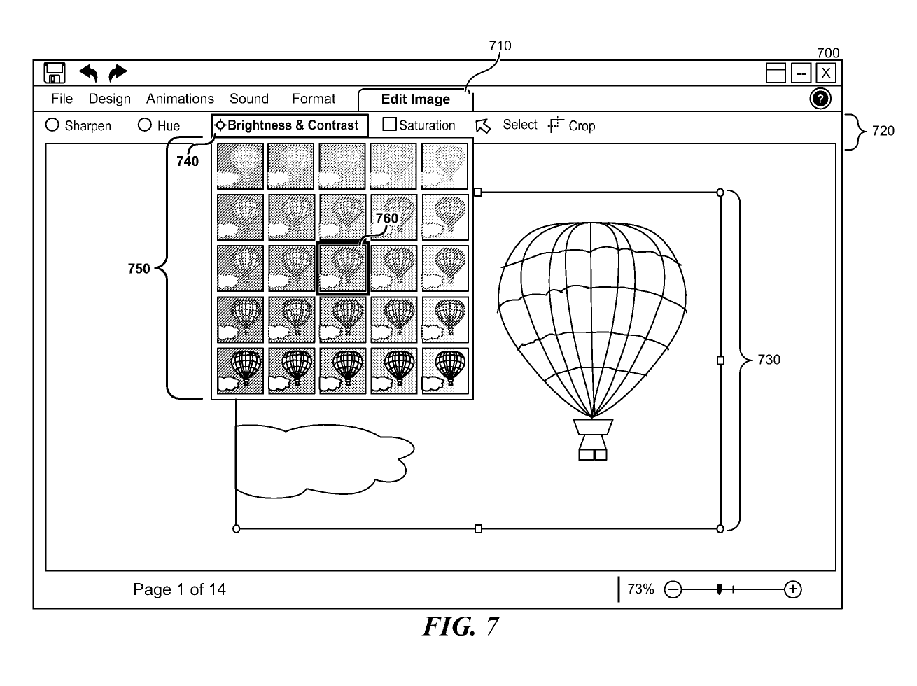

FIG. 7 is a display diagram that illustrates the digital image editing system in the context of a document creation application, in one embodiment. The display 700 illustrated is that of a presentation application. The display 700 contains a set of tabs 710 and a ribbon bar 720 from which the user can select various functions provided by the application for adding and modifying elements of a document 730. The document 730 illustrated is a slide of a presentation that contains only an image. When the user selects the image, the application invokes the digital image editing system to display controls on the ribbon bar 720 for modifying the image. The ribbon bar 720 contains a brightness and contrast button 740 that, when selected, displays the thumbnail gallery 750 as described herein. The center thumbnail contains a highlight 760 that indicates that it is currently selected. As the user hovers over each thumbnail in the thumbnail gallery, the system may update the image in the document 730 to provide a “live preview” of the effect on the image if the user selects that thumbnail.

From the foregoing, it will be appreciated that specific embodiments of the digital image editing system have been described herein for purposes of illustration, but that various modifications may be made without deviating from the spirit and scope of the invention. For example, although particular filters and effects, such as brightness and contrast, have been described, those of ordinary skill in the art will recognize that a vast variety of digital filters and effects can be used with the system described. In addition, although images have been described in some examples in a document context, the digital image editing system can be used to modify images in many different environments. Accordingly, the invention is not limited except as by the appended claims.

I/We claim:

1. A computer-based method for selecting a parameter value of a filter to apply to an image, the method comprising:
receiving a selection of a filter from a set of available filters;
determining a range of parameter values for a parameter of the selected filter;
creating multiple thumbnails of the image, each thumbnail illustrating a representation of the image with a different parameter value within the range of parameter values of the filter applied to the image, wherein the thumbnail is created by applying the filter using a parameter value different than the parameter value that the thumbnail illustrates for the image; and
displaying the multiple thumbnails in a user interface from which a user can select a thumbnail to apply the parameter value illustrated by the selected thumbnail.

2. The method of claim 1 wherein the selected filter is selected from the group consisting of a brightness filter, a contrast filter, a sharpness filter, a color saturation filter, a color temperature filter, a sepia toning filter, a hue filter, and a tone filter.

3. The method of claim 1 further comprising determining a second range of parameter values of a second parameter and creating thumbnails in a two-dimensional matrix, wherein one axis of the matrix represents values of the first parameter and the other axis represents values of the second parameter.

4. The method of claim 1 wherein the image is at least partially visible when the thumbnails are displayed, and when the user hovers a selection device over one of the multiple thumbnails, the appearance of the image changes to match the parameter value of the thumbnail.

5. The method of claim 1 further comprising, when the user hovers a selection device over one of the multiple thumbnails, displaying help text that specifies the parameter value represented by the thumbnail.

6. The method of claim 1 further comprising, receiving a selection from the user of one of the multiple thumbnails and applying the filter to the image using the parameter value represented by the selected thumbnail.

7. The method of claim 6 further comprising, before applying the filter to the image, storing the original image so that the changes can be reversed.

8. The method of claim 1 wherein determining a range of parameter values comprises determining the range heuristically based on past parameter values selected by one or more users.

9. The method of claim 1 wherein determining a range of parameter values comprises determining the range based on attributes of the image.

10. The method of claim 1 wherein determining a range of parameter values comprises selecting a predefined range based on the selected filter.

11. A system for modifying digital images by selecting thumbnail from a visual representation of modifications to the image, the system comprising:
a filter library configured to manage one or more filters that a user of the system can select to modify a digital image;
a parameter evaluation component configured to determine a range of parameter values of the selected filter to display to the user;
a thumbnail generation component configured to generate thumbnails of the image representing an effect of applying the filter using each of the determined parameter values; and
a user interface component configured to display the generated thumbnails to the user.

12. The system of claim 11 further comprising a user input component configured to receive a thumbnail selection from the user and apply the selected filter to the digital image using the parameter value represented by the selected thumbnail.

13. The system of claim 11 further comprising an image storage component configured to store an original copy of the digital image and one or more modifications to the digital image;

14. The system of claim 13 wherein the image storage component stores the one or more modifications as a filter chain that describes changes based on the original copy of the digital image.

15. The system of claim 13 wherein the image storage component is further configured to store a flattened version of the digital image with all of the changes applied.

16. The system of claim 11 wherein the filter library allows the user to install new filters that integrate with the system to allow new effects to be applied to images.

17. A computer-readable storage medium encoded with instructions for controlling a computer system to receive an additional modification to a previously modified digital image embedded within a document, by a method comprising:
receiving the digital image and an indication of a first modification to the digital image, wherein the indication identifies a first filter and a first parameter value of the first filter;
receiving a selection of a second filter, the second filter having one or more parameter values that modify the effect of the second filter on the digital image;
displaying a gallery of thumbnails illustrating a range of at least one of the parameter values of the second filter, wherein each thumbnail is modified according to the first filter and first parameter value and illustrates the cumulative effect of applying the first filter and the second filter.

18. The computer-readable medium of claim 17 wherein at least one of the first and second filters is selected from the group consisting of: brightness, contrast, color saturation, and color temperature.

19. The computer-readable medium of claim 17 further comprising receiving a request to display an advanced settings dialog, wherein the advanced settings dialog through which a user can select a parameter value of the second filter that is not illustrated by the thumbnail gallery.

20. The computer-readable medium of claim 17 wherein the thumbnail gallery highlights the thumbnail of the currently selected at least one parameter value of the second filter.
